(19) United States
(12) Patent Application Publication
(10) Pub. No.: US 2023/0359931 A1
(43) Pub. Date: Nov. 9, 2023

(54) MACHINE LEARNING APPARATUS, MACHINE LEARNING METHOD AND COMPUTER-READABLE STORAGE MEDIUM

(71) Applicant: NEC, Corporation, Minato-ku, Tokyo (JP)

(72) Inventor: Isamu TERANISHI, Tokyo (JP)

(73) Assignee: NEC Corporation, Minato-ku, Tokyo (JP)

(21) Appl. No.: 18/013,759

(22) PCT Filed: Jul. 3, 2020
(86) PCT No.: PCT/JP2020/026187

§ 371 Date: Dec. 29, 2022

(51) Int. Cl. G06N 20/00; G06N 5/04

(52) U.S. Cl. CPC G06N 20/00; G06N 5/04

(57) ABSTRACT

A machine learning apparatus according to the embodiment including: n (n is an integer greater than or equal to 2) inference units which are machine learning models trained using training data; and a classifier configured to classify an input data and to output an output data. A first inference unit from among the n inference units performs inference based on the input data when the output data of the classifier is a first value. At least one inference unit other than the first inference unit is trained using the input data when the output data of the classifier is the first value as the training data.

### TECHNICAL FIELD

The present disclosure relates to machine learning.

### BACKGROUND ART

Non-Patent literature 1 discloses a machine learning method having resistance to Membership inference attacks (hereinafter referred to as MI attack).

### CITATION LIST

### Non-Patent Literature

[Non Patent Literature 1] Machine Learning with Membership Privacy using Adversarial Regularization. Milad Nasr, Reza Shokri, Amir Houmansadr
https://arxiv.org/pdf/1807.05852.pdf

### SUMMARY OF INVENTION

### Technical Problem

In machine learning, data used for learning (also known as training data) may contain confidential information such as customer information and trade secrets. There is a possibility that the confidential information used for the learning may be caused to leak from the learned parameters of the machine learning by a MI attack. For example, an attacker who has illegally obtained a learned parameter may guess the learning data. Alternatively, even if the learned parameters are not leaked, an attacker can predict the learned parameters by repeatedly accessing the inference algorithm. Then, the learning required data may be predicted from the predicted learned parameters.

In Non-Patent literature 1, accuracy and attack resistance are in a trade-off relationship. Specifically, parameters that determine the degree of a trade-off between accuracy and attack resistance are set. Therefore, it is difficult to improve both accuracy and attack resistance.

One of objects of the present disclosure is to provide a machine learning apparatus, a machine learning method, and a recording medium having high resistance to MI attacks and high accuracy.

### Solution to Problem

A machine learning apparatus according to the present disclosure includes: 1. n (n is an integer greater than or equal to 2) inference units which are machine learning models trained using training data; and a classifier configured to classify an input data and to output an output data; a first inference unit from among the n inference units performs inference based on the input data when the output data of the classifier is a first value and at least one inference unit other than the first inference unit is trained using the input data when the output data of the classifier is the first value as the training data.

A machine learning apparatus according to the present disclosure is a machine learning method of a machine learning apparatus, the machine learning apparatus comprising; n (n is an integer greater than or equal to 2) inference units which are machine learning models trained using training data; and a classifier configured to classify an input data and to output an output data; the machine learning method comprising; performing inference by a first inference unit from among the n inference units based on the input data when the output data of the classifier is a first value and training at least one inference unit other than the first inference unit using the input data when the output data of the classifier is the first value as the training data.

A non-transitory computer-readable storage medium according to the present disclosure is a non-transitory computer-readable storage medium storing a program that causes a computer to execute a method of the machine learning apparatus: the machine learning apparatus comprising; n (n is an integer greater than or equal to 2) inference units which are machine learning models trained using training data; and a classifier configured to classify an input data and to output an output data; the method comprising; performing inference by a first inference unit from among the n inference units based on the input data when the output data of the classifier is a first value and training at least one inference unit other than the first inference unit using the input data when the output data of the classifier is the first value as the training data.

### Advantageous Effects of Invention

According to the present disclosure, a machine learning system, a machine learning method, and a program having high resistance to MI attacks and high accuracy can be provided.

### BRIEF DESCRIPTION OF DRAWINGS

FIG. 1 is a block diagram illustrating a machine learning apparatus according to the present disclosure.

FIG. 2 is a diagram for explaining a flow during training in the first embodiment.

FIG. 3 is a diagram for explaining a flow during inference in the first embodiment.

FIG. 4 is a diagram for explaining a flow during training in the second embodiment.

FIG. 5 is a diagram for explaining a flow during inference in the second embodiment.

FIG. 6 is a block diagram illustrating a machine learning apparatus according to the third embodiment.

FIG. 7 is a block diagram showing a hardware structure of the machine learning apparatus.

### DESCRIPTION OF EMBODIMENTS

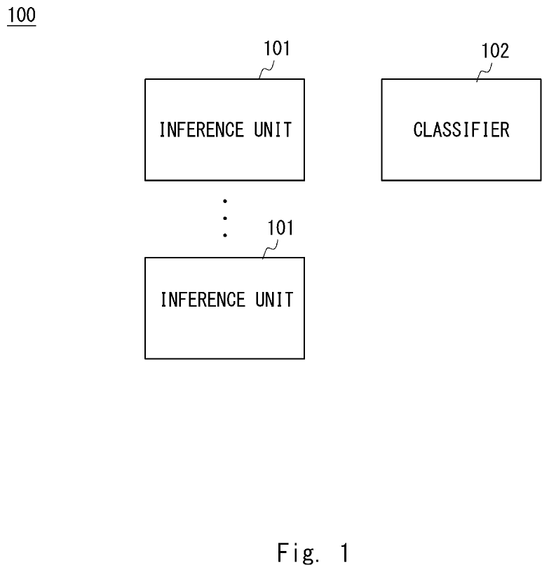

A machine learning apparatus according to this embodiment will be described with reference to FIG. 1. FIG. 1 is a block diagram showing the configuration of the machine learning apparatus 100. The machine learning apparatus 100 includes n (n is an integer greater than or equal to 2) inference units 101 and a classifier 102.

The n inference units 101 are machine learning models trained using training data. The classifier 102 is configured to classify input data and outputs output data. A first inference unit 101 from among the n inference units 101 performs inference based on the input data when the output data of the classifier is a first value. At least one inference unit 101 other than the first inference unit 101 is trained using the input data when the output data of the classifier is the first value as the training data.

According to this configuration, a machine learning apparatus having high resistance to MI attack and high inference accuracy can be realized.

### First Embodiment

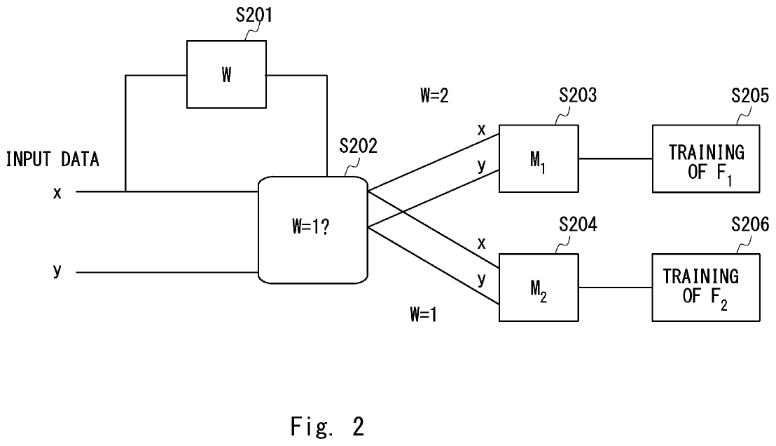

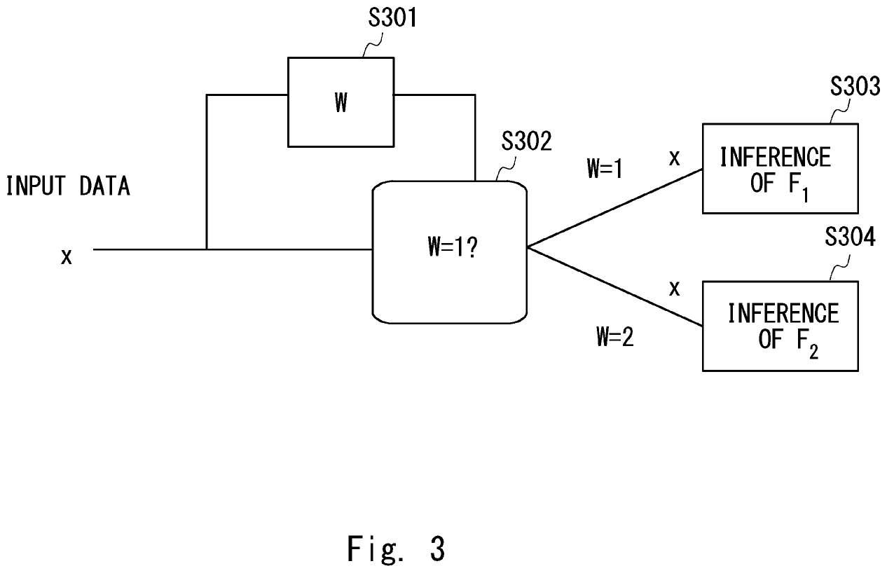

A machine learning apparatus and a machine learning method according to this embodiment will be described with reference to FIGS. 2 and 3. FIGS. 2 and 3 are diagrams for explaining processing of the machine learning method according to the present embodiment. FIG. 2 shows the flow during training. FIG. 3 shows the flow during inference. In the present embodiment, the number of inference units 101 shown in FIG. 1 is two.

Here, two inference units are referred to as an inference unit F₁ and an inference unit F₂. The inference unit F₁ and the inference unit F₂ are machine learning models. The inference unit F₁ and the inference unit F₂ may be the same model or may be different models. For example, when the inference unit F₁ and the inference unit F₂ are neural network models such as DNN (Deep Neural Network), the number of layers and the number of nodes in each layer may be the same. The inference unit F₁ and the inference unit F₂ are inference algorithm using a convolutional neural network (CNN). The parameters of the inference units F₁ and F₂ may correspond to weights or bias values in the convolutional layers, pooling layers and fully connected layers in CNN.

First, a flow in the training will be described with reference to FIG. 2. The parameters of the inference units F₁ and F₂ are tuned by machine learning. Here, supervised learning is performed for the inference units F₁ and F₂. A correct answer label (also called teacher signal or teacher data) for input data x which is training data is defined as a label x. The label y is associated with input data x to become training data.

A classifier W classifies input data into two training data M₁ and M₂. Specifically, the classifier W classifies the input data x and outputs 1 or 2. The classifier W is preferably an output device that does not use random numbers. That is, the classifier W outputs deterministic output data for the input data x. Therefore, when the same input data is input to the classifier W, the output data always matches. The output data to the input data x becomes deterministic (definite).

In training, the machine learning apparatus receives a training data set T as an input. The training data set T includes a plurality of input data x. Each input data x becomes training data. In the supervised learning, a label y is associated with each input data x.

First, input data x is input to the classifier W (S 201). Then, the machine learning apparatus determines whether or not the value of W is 1 (S 202).

The machine learning apparatus uses the input data x when W=2 as the training data M₁ of the inference unit F₁ (S 203). The machine learning apparatus uses the input data x when W=1 as the training data M₂ of the inference unit F₂ (S 204). For i=1, 2, the classifier W classifies the training data set T as equation (1).

[Equation 1]

Mi={(x,y)∈T|W(x)≠i} (1)

The inference unit Fᵢ is then trained with the training data Mi. That is, the inference unit F₁ is trained with the training data M₁ (S 205). An inference unit F₂ is trained with training data M₂ (S 206). That is, machine learning is performed for the inference unit F₁ using the training data M₁. Machine learning is performed for the inference unit F₁ by using the training data M₂. In other words, the training data M₁ is not used for training the inference unit F₂. Similarly, the training data M₂ is not used for training the inference unit F₁.

In training, supervised learning is performed for the inference units F₁ and F₂ by using the label x. The parameters are optimized so that the inference results of the inference units F₁ and F₂ match the label x.

Next, the flow at the time of inference will be described. An inference unit F₁ or an inference unit F₂ trained in accordance with the flow shown in FIG. 2 is used for inference.

First, input data x is input to the classifier W (S 301). Then, the machine learning apparatus determines whether or not the value of W is 1 (S 302). When W=1, the inference unit F₁ performs inference (S 303). That is, the input data x is input to the inference unit F₁ in order for the inference unit F₁ to output the inference result. When W=2, the inference unit F₂ performs inference (S 304). In order for the inference unit F₂ to output the inference result, the input data x is inputted to the inference unit F₂.

The inference unit F₂ does not perform inference based on the input data x when W=1. The inference unit F₁ does not perform inference on the basis of the input data x when W=2. Thus, at the time of inference, the machine learning apparatus receives the input data x and returns F₍ₓ₎ (x). That is, if W (x)=i, the machine learning apparatus outputs Fᵢ (x) as an inference result.

The effects of the machine learning apparatus according to the present embodiment will be described below. In a machine learning apparatus, the tendency of the output of an inference unit in a case where data is used for training differs from that in a case where data is not used for training. The attacker attacks the machine learning models by using this above difference in the tendency of the output of the inference unit. For example, it is assumed that the inference accuracy (estimation accuracy) of the inference unit is much higher for the input data used for training than for the input data not used for training. Therefore, the attacker can estimate the training data by comparing the inference accuracy in the above first case with that in the above second case.

On the other hand, in the present embodiment, the inference units used in training differ from the inference units used in inference. In other words, for the input data x used to train the inference unit F₁, the inference unit F₁ (x) is not output during inference. Further, for the input data x used to train the inference unit F₂, the inference unit F₂ (x) is not output during inference.

Therefore, the resistance against the MI attack can be improved. That is, even if an attacker illegally obtains learned parameters, the training data cannot be inferred. Further, since, unlike in the case of Non-Patent literature 1, MI attack resistance and inference accuracy are not in a trade-off relationship, inference accuracy can be improved.

Preferably, the classifier W outputs 1 and 2 for the training data set T with substantially the same probability as each other. That is, the classifier W outputs 1 or 2 with an equal probability of 50%. Thus, the number of training data of the inference unit F₁ and that of the inference unit F₂ can be made to be almost the same as each other. Therefore, high inference accuracy can be realized in any of the inference units.

### Second Embodiment

In the present embodiment, the number of inference units 101 in FIG. 1 is n (n is an integer greater than or equal to 2). That is, in the second embodiment, the number of inference units is generalized as n. In the following description, n is assumed to be 3 or more. Since the basic configuration other than the number of inference units, and processing are the same as those of the first embodiment, the description thereof is omitted.

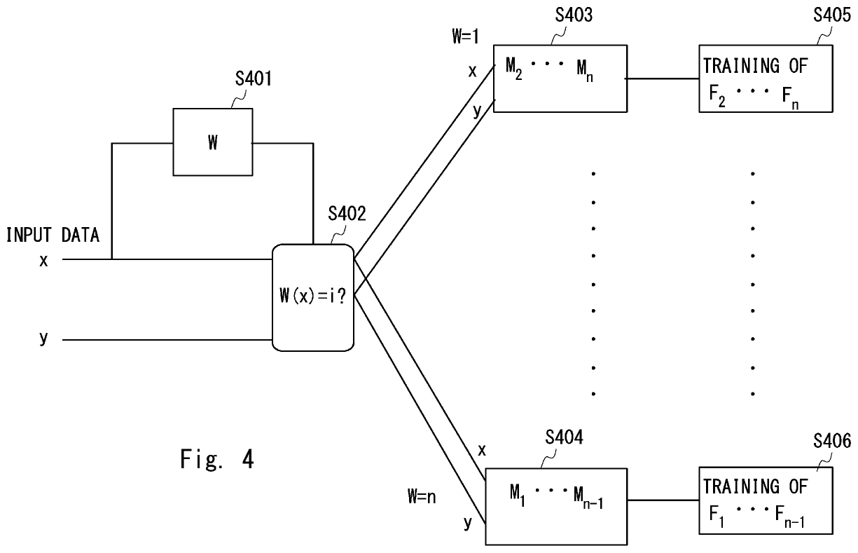

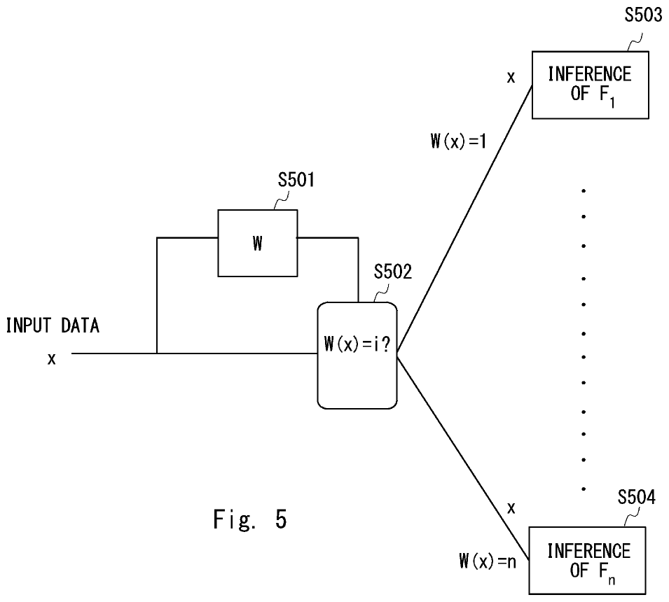

Processing in the machine learning apparatus according to the present embodiment will be described. FIGS. 4 and 5 are diagrams for explaining a machine learning method according to the present embodiment. FIG. 4 shows the flow during training. FIG. 5 shows the flow during the inference.

As described above, in the present embodiment, the machine learning apparatus has n inference units. The inference units are shown as F₁, . . . Fₙ. In this embodiment, i is defined as an arbitrary integer from 1 to n.

First, a flow at the time of the training will be described with reference to FIG. 4. By machine learning, the parameters of the inference units F₁ to Fₙ are tuned. Here, supervised learning is performed for the inference units F₁ to Fₙ. A correct answer label (also called teacher signal or teacher data) for input data x which is training data is defined as a label x. The label y is associated with input data x to become training data.

A classifier W classifies input data x into training data M₁ to Mₙ. The training data M₁ is used for training the inference unit and the training data Mₙ is used for training the inference unit Fₙ. Specifically, the classifier W classifies the input data x and outputs any integer from 1 to n. That is, the classifier W outputs an integer equal to or smaller than n according to the input data x.

The classifier W is preferably an output device that does not use random numbers.

That is, the classifier W outputs deterministic output data for the input data x. The classifier W preferably equally outputs an integer of 1 to n. In the classifier Wn, n classification results appear with approximately the same probability as each other.

In training, the machine learning apparatus receives a training data set T as an input. The training data set T includes a plurality of input data x. First, input data x is input to the classifier W (S 401). Then, the machine learning apparatus determines whether or not the value of W is i (S 402). Here, i is an arbitrary integer of 1 to n. That is, the machine learning apparatus obtains the output data of W.

The machine learning apparatus classifies input data x into training data M₁ to Mₙ based on the output data of W. The machine learning apparatus uses the input data x when W=1 as the training data M₂ to Mₙ of the inference units F₂ to Fₙ (S 403). The machine learning apparatus sets the input data x when W=n to the training data M₁ to Mₙ₋₁ of the inference units F₁ to Fₙ₋₁ (S 404). For i=1 to n, the classifier W classifies the training data set T as Eq. (2).

[Equation 2]

Mi={(x,y)∈T|W(x)≠i} (2)

The inference unit Fᵢ is then trained with Mᵢ. That is, when W=1, the inference units F₂ to Fₙ are trained with the training data M₂ to Mₙ (S 405). When W=n, the inference units F₁ to Fₙ₋₁ train with the training data M₁ to Mₙ₋₁ (S406). Generally speaking, the input data x when W=i is not used for training the inference unit Fᵢ.

Next, the flow at the time of inference will be described. Inference units F₁ to Fₙ trained in accordance with the flow shown in FIG. 5 are used for inference.

First, input data x is input to the classifier W (S 501). Then, the machine learning apparatus determines whether or not the value of W is i (S 502). When W=1, the inference unit F₁ performs inference (S 503). That is, the input data x is input to the inference unit F₁ in order for the inference unit F₁ to output the inference result. When W=n, the inference unit Fₙ performs inference (S 304). In order for the inference unit Fₙ to output the inference result, the input data x is input to the inference unit Fₙ.

Generally speaking, when W=i, the inference unit F₁ performs inference. In other words, the inference unit F₁ does not perform inference based on the input data x when W is not equal to i. Thus, at the time of inference, the machine learning apparatus receives the input data x and returns F_{w(x)} (x). That is, when W (x)=i, the machine learning apparatus outputs Fᵢ (x) as an inference result. The inference unit Fᵢ from among the inference units F₁ to Fₙ performs inference based on the input data x when the output data of the classifier W is i. The inference units other than the inference unit Fᵢ is trained using the input data x when the output data of the classifier is i as the training data.

Therefore, as in the first embodiment, the resistance against the MI attack can be improved. Further, in this embodiment, the training data of the inference unit can be increased. That is, if the original number of the training data set T is m (m is an integer greater than or equal to 2), the inference unit F₁ can be trained using (m*(n−1)/n) pieces of training data.

In general, the greater the number of training data, the better the inference accuracy of the inference unit. Therefore, the inference accuracy can be improved as compared with that of the first embodiment. The classifier W preferably outputs integers 1 to n with substantially the same probability as each other. The classifier W outputs integers 1 to n with a probability of 1/n. In this way, the deviation of the training data can be suppressed, so that the inference accuracy of all the inference units can be improved.

### Third Embodiment

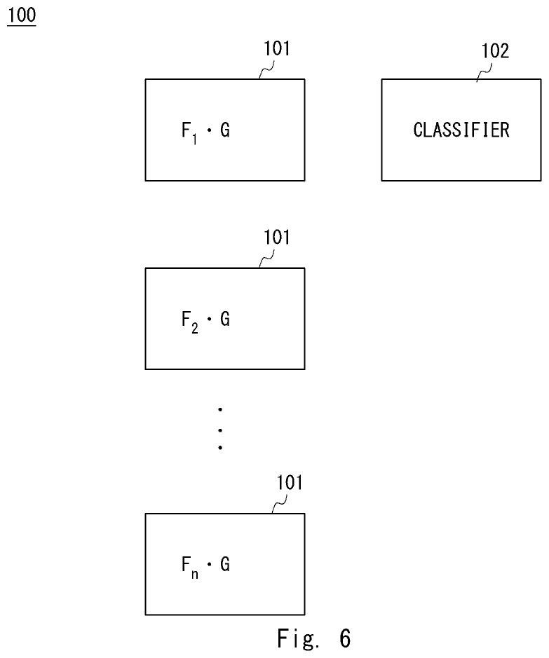

The machine learning apparatus 100 according to the third embodiment will be described with reference to FIG. 6. FIG. 6 is a block diagram showing the configuration of the machine learning apparatus 100. In FIG. 6, a plurality of inference unit 101 are shown as inferences F₁.G, F₂.G, . . . , and Fₙ.G. n is an integer greater than or equal to 2.

In this embodiment, the inference unit 101 has a common model G having a common parameter among the plurality of inference units 101. Further, the inference unit 101 has non-common models F₁, F₂, . . . , Fₙ having parameters which are not common among the plurality of inference units 101. The first inference unit 101 includes a common model G and a non-common model F₁. The n-th inference unit 101 includes a common model G and a non-common model Fₙ.

When the inference unit 101 is a neural network model having a plurality of layers, the common model G includes a part of layers of the neural network. For example, the common model G is the first one or more layers of the neural network, and non-common models F₁, F₂, . . . , Fₙ are arranged in a post-stage of the common model G. In the plurality of inference unit 101, the common models G have the same layer structure and have the same parameters as each other. The non-common models F₁, F₂, . . . , Fₙ have different parameters from each other. Since the contents other than the common model G are the same as those of the first and second embodiments, a description thereof will be omitted. For example, the classifier W is similar to the classifier W in the second embodiment.

The common model G are learned to have the same parameters as each other during training. Non-common models F₁, F₂, . . . , Fₙ are machine learned to have different parameters from each other during training. In training, for i=1 to n, the classifier W classifies the training data set T as in Equation (2) as set forth above.

The first inference unit F₁.G is trained using the training data Mi. Here, the parameters of non-common model F₁ and the parameters of the common model G are optimized. Next, the second inference unit F₂.G is trained using the training data M₂. In this case, only the parameters of non-common model F₂ are optimized. That is, since the parameters of the common model G are determined at the time of training using the training data M₁, the parameters of the common model G are not changed.

In general, for i=2, . . . , n, the inference unit Fᵢ.G is trained with the training data Mᵢ. Here, the parameters of the common model G are fixed, and only the parameters of non common model Fᵢ are trained.

The training of the common model G is not limited to the training of the inference unit F₁.G. The common model G may be trained during the training of any one of inference units 101. The common model is trained using the training data Mᵢ. For example, when the inference unit Fᵢ.G is first trained, the parameters of the common model G are determined by the training of the inference unit Fᵢ.G.

At the time of inference, the machine learning apparatus 100 receives the input data x and returns F_{w (x)} (G (x)). That is, when W=the machine learning apparatus 100 outputs Fᵢ (G (x)). In this way, some parameters of the plurality of inference unit 101 can be made common. Therefore, it is possible to perform training efficiently.

In the above embodiments, each of the machine learning apparatus can be implemented by a computer program. That is, the inference unit and the classifier can be implemented by a computer program. Also, the n inference units and the classifiers may not physically comprise a single device, but may be distributed among a plurality of computers.

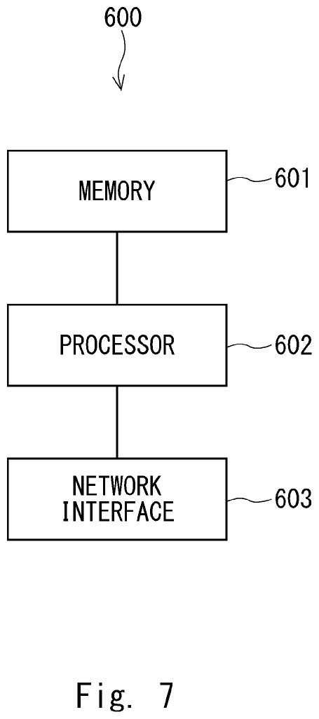

Next, a hardware configuration of the machine learning apparatus will be described. FIG. 7 is a block diagram showing an example of a hardware configuration of the machine learning apparatus 600. As shown in FIG. 7, the machine learning apparatus 600 includes, for example, at least one memory 601, at least one processor 602, and a network interface 603.

The network interface 603 is used to communicate with other apparatuses through a wired or wireless network. The network interface 603 may include, for example, a network interface card (NIC). The machine learning apparatus 600 transmits and receives data through the network interface 603. For example, the machine learning apparatus 600 may acquire the input data x.

The memory 601 is formed by a combination of a volatile memory and a nonvolatile memory. The memory 601 may include a storage disposed remotely from the processor 602. In this case, the processor 602 may access the memory 601 through an input/output interface (not shown).

The memory 601 is used to store software (a computer program) including at least one instruction executed by the processor 602. The memory 601 may store the inference units F₁ to Fₙ as the machine learning models. The memory 601 may store the classifier W.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

### REFERENCE SIGNS LIST

100 machine learning apparatus
101 inference unit
102 classifier
600 machine learning apparatus
601 memory
602 processor
603 network interface

What is claimed is:

1. A machine learning apparatus comprising;
n (n is an integer greater than or equal to 2) inference units which are machine learning models trained using training data; and
a classifier configured to classify an input data and to output an output data;
a first inference unit from among the n inference units performs inference based on the input data when the output data of the classifier is a first value and
at least one inference unit other than the first inference unit is trained using the input data when the output data of the classifier is the first value as the training data.

2. The machine leaning apparatus according to claim 1,
wherein the classifier outputs deterministic output data with respect to the input data.

3. The machine leaning apparatus according to claim 1,
wherein the classifier outputs N classification results, and
n classification results appear with substantially the same probability as each other.

4. The machine leaning apparatus according to claim 1,
the n inference unit includes a common model having common parameter among the n inference unit,
the common model is trained using the input data when the output data of the classifier is the first value as the training data.

5. A machine learning method of a machine learning apparatus,
the machine learning apparatus comprising;
n (n is an integer greater than or equal to 2) inference units which are machine learning models trained using training data; and
a classifier configured to classify an input data and to output an output data;
the machine learning method comprising;
performing inference by a first inference unit from among the n inference units based on the input data when the output data of the classifier is a first value and
training at least one inference unit other than the first inference unit using the input data when the output data of the classifier is the first value as the training data.

6. The machine leaning method according to claim 5,
wherein the classifier outputs deterministic output data with respect to the input data.

7. The machine leaning method according to claim 5,
wherein the classifier outputs N classification results, and
n classification results appear with substantially the same probability as each other.

8. A non-transitory computer-readable storage medium storing a program that causes a computer to execute a machine learning method:
the computer comprising;
n (n is an integer greater than or equal to 2) inference units which are machine learning models trained using training data; and
a classifier configured to classify an input data and to output an output data;
the method comprising;
performing inference by a first inference unit from among the n inference units based on the input data when the output data of the classifier is a first value and
training at least one inference unit other than the first inference unit using the input data when the output data of the classifier is the first value as the training data.

9. The non-transitory computer-readable storage medium according to claim 8,
wherein the classifier outputs deterministic output data with respect to the input data.

10. The non-transitory computer-readable storage medium according to claim 8,
wherein the classifier outputs N classification results, and
n classification results appear with substantially the same probability as each other.
